(19) United States
(12) Patent Application Publication
(10) Pub. No.: US 2006/0076383 A1
(43) Pub. Date: Apr. 13, 2006

(54) Tape dispenser with configured side walls

(76) Inventor: Robert G. Dickie, Newmarket (CA)

Correspondence Address: SAND & SEBOLT, AEGIS TOWER, SUITE 1100, 4940 MUNSON STREET, NW, CANTON, OH, 44718-3615, US

(21) Appl. No.: 10/943,735

(22) Filed: Oct. 12, 2004

(51) Int. Cl. B26F 3/02

(52) U.S. Cl. 225/39

(57) ABSTRACT

A tape dispenser for young children. The dispenser includes first and second sides that are formed in the shape of an animal and more particularly in the shape of a turtle or snail. The first and second sides are connected together to form a chamber into which a roll of tape is inserted. Each of the first and second sides includes an end portion that is enlarged. A cutter blade is mounted between the enlarged end portions and is positioned a spaced distance inwardly from an outer edge of each end portion. The upper and outer walls of the dispenser include a plurality of ridges to aid in the gripping of the dispenser. The ridges are shaped and positioned to represent the shells of either a turtle or a snail.

### BACKGROUND OF THE INVENTION

1. Technical Field

This invention relates generally to tape dispensers. More specifically, the invention relates to tape dispensers for young children. Particularly, the invention relates to a tape dispenser which has sidewalls configured for easy gripping and that includes a recessed blade and rounded upper walls for protecting small hands.

2. Background Information

A wide variety of adhesive tape dispensers have been proposed in the prior art. Typically, these dispensers have a side wall, an upper wall and a bottom wall. A tape support extends outwardly from the inner surface of the side wall and the roll of adhesive tape is received on this support. A cutter blade projects outwardly from the inner wall proximate the front end of the dispenser and the tape is pulled over the cutter blade to cut small pieces of the same therefrom.

The dispensers of the prior art function well, but may be problematic when used by small children. Prior art dispensers are designed to be disposable and are therefore typically manufactured with only one side wall to reduce the cost of materials. This leaves the rotating roll of tape open on one side and leaves the cutter blade exposed. Children have small hands and they therefore need to grasp the dispenser tightly. Their fingers therefore tend to wrap around only a portion of the dispenser and come into contact with the roll of tape. As they try to pull the free end of the tape over the cutter blade, their smaller fingers tend to interfere with the rotation of the roll of tape. This can lead to frustration on their part causing them to grip the dispenser more tightly and to pull on the free end of the tape more vigorously in order to break a piece of tape off of the roll. Because the dispensers are missing one side wall, the child's fingers can also get stuck on the adhesive side of the tape leading to more frustration. As they hold the dispenser more tightly and pull harder on the free end of the tape, they may accidentally come into contact with the exposed cutter blade and hurt themselves.

There is therefore a need in the art to provide a tape dispenser which is safer and easier for young children to use.

### BRIEF SUMMARY OF THE INVENTION

The tape dispenser of the present invention has first and second sides which each have an inner wall, an outer wall, an upper wall and a bottom wall. The first and second sides are connected to each other to form a chamber into which the roll of tape is received. A tape support extends between the inner walls of the first and second sides. When a roll of adhesive tape is received on the support, it is substantially concealed within the chamber. The upper wall and outer walls of the dispenser are provided with patterned ridges to assist the younger child to grip the dispenser. The dispenser has a rear section and a forward section. The forward section includes an enlarged end portion into which the cutter blade is recessed to reduce the tendency for contact with the cutting surface by small fingers. In order to make the dispenser more appealing to the younger child, the sides of the dispenser are shaped into the form of an animal which appeals to children, such as a turtle or snail. The patterning of the ridges assists in creating the shape of the animal while providing a good gripping surface for small hands. The dispenser preferably is provided with product information cards which enhance the features of the animal character. The cards abut the inner wall of the first and second sides of the dispenser.

### BRIEF DESCRIPTION OF THE SEVERAL VIEWS OF THE DRAWINGS

Preferred embodiments of the invention, illustrative of the best modes in which applicant contemplates applying the principles, are set forth in the following description and are shown in the drawings and are particularly and distinctly pointed out and set forth in the appended claims.

FIG. 1 is a perspective view of a first embodiment of the tape dispenser in accordance with the present invention and showing the first side and the back of the dispenser;

FIG. 2 is an exploded perspective view of the tape dispenser of FIG. 1;

FIG. 3 is a perspective view of the tape dispenser of FIG. 1, showing the first side and the front end of the dispenser;

FIG. 4 is a perspective view of the tape dispenser of FIG. 1, showing the second side of the dispenser;

FIG. 4A is a perspective view of the tape dispenser showing the addition of a product information card;

FIG. 5 is a perspective view of a second embodiment of the tape dispenser in accordance with the present invention showing the first side and the front of the dispenser;

FIG. 6 is a perspective view of the tape dispenser of FIG. 5, showing the first side and the back of the dispenser;

FIG. 7 is a perspective view of the tape dispenser of FIG. 5, showing the second side of the dispenser; and

FIG. 7A is a perspective view of the tape dispenser showing the first side and the back of the dispenser with the addition of a product information card.

### DETAILED DESCRIPTION OF THE INVENTION

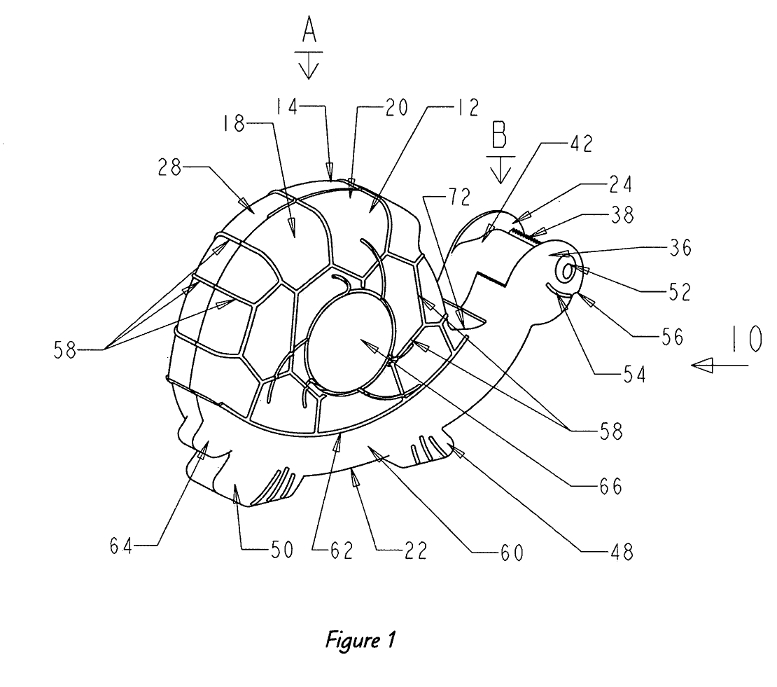

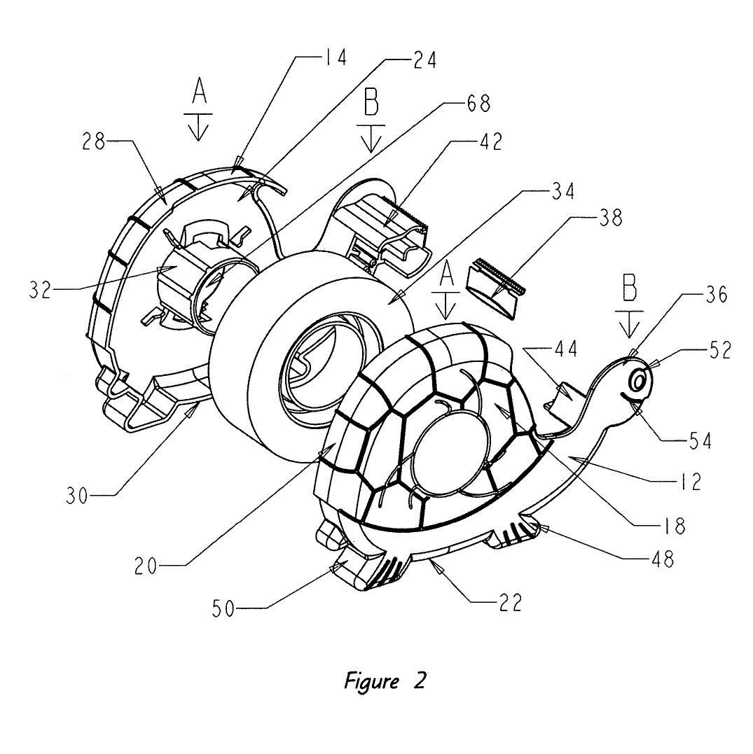

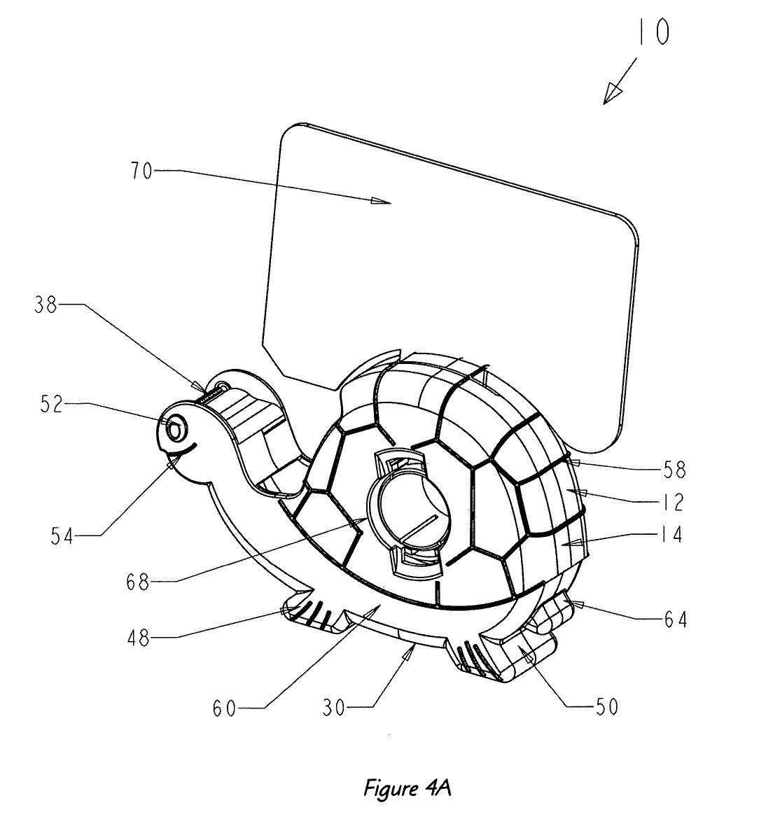

Referring to FIGS. 1-4A, there is shown a first embodiment of a tape dispenser in accordance with the present invention and generally indicated at 10. Dispenser 10 has a first side 12 and a second side 14 which are substantially identical in shape. First and second sides 12, 14 preferably are snap-fitted together but may alternatively be adhesively attached to each other or connected together in any other suitable manner. First side 12 includes an inner wall 16 (FIG. 4), an outer wall 18, an upper wall 20 and a bottom wall 22. Second side 14 includes an inner wall 24 (FIG. 2), an outer wall 26, an upper wall 28 and a bottom wall 30. First and second sides 12, 14, preferably are molded from a material such as polystyrene.

A tape support 32 (FIG. 2) extends from the inner wall 24 of second side 14 toward the inner wall 16 of first side 12. A roll of adhesive tape 34 is received on support 32. A cooperating tape support (not shown) may extend from inner wall 16 of first side 12 and toward inner wall 24 of second side. In the latter instance, the pair of supports would interlock together to hold the roll of adhesive tape thereon.

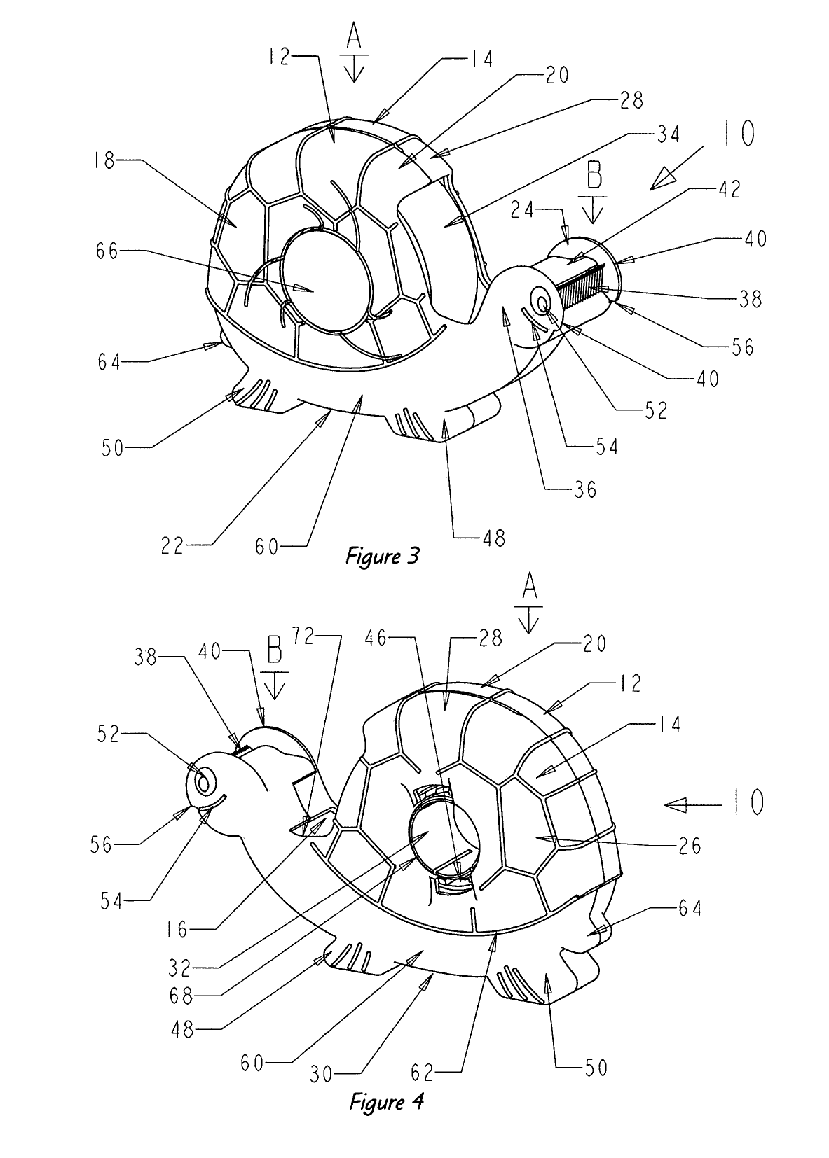

In accordance with the present invention, each of first and second sides 12, 14 are shaped to have a rear section, generally indicated at “A”, and a forward section, generally indicated at “B”. Rear section A, of each side 12, 14, is generally circular in shape and the roll of tape 34 is received within a chamber (not shown) formed between rear sections A of first and second sides 12, 14. Forward section B extends outwardly from rear section A and includes an enlarged, generally circular end portion 36. A cutter blade 38 is mounted between end portions 36 of first and second sides. Cutter blade 38 lies spaced inwardly from an outer edge 40 of each end portion 36 (FIG. 3). Cutter blade is mounted on a tab 42 (FIG. 2) which extends outwardly from the inner surface 24 of second side 14. A second tab 44 extends outwardly from inner surface 16 of first side 12 and tabs 42, 44 interlock to secure end portions 36 of first and second sides 12, 14 together. Rear sections A of first and second sides 12, 14 are secured together by interlocking tape support 32 and a tab 46 (FIG. 4).

A pair of spaced apart projections 48, 50 extend outwardly from bottom walls 22, 30 of first and second sides 12, 14. Projection 48 extends outwardly from bottom walls 22, 30 at an angle and extends toward the front end of dispenser 10. Projection 50 extends outwardly from bottom walls 22, 30 at an angle and extends toward the rear end of dispenser 10. Projections 48, 50 can be used to stand dispenser 10 upright on a surface.

Inasmuch as dispenser 10 is designed for safer and easier use by young children, dispenser 10 is shaped to appeal to such users. First and second sides 12, 14 are therefore manufactured in the shape of an animal that appeals to young children, such as a turtle (FIGS. 1-4). Rear section A is shaped as a turtle shell, forward section B is shaped as a turtle's head and neck and projections 48, 50 are shaped as turtle feet. End portion 36 includes a molded eye 52, mouth 54 and beak 56.

In accordance with the present invention, a plurality of ridges 58 are provided on rear section A to aid in gripping the dispenser 10. Ridges 58 are generally polygonal in shape to imitate the segments of a turtle's shell. Ridges 58 are formed in rear section A on upper walls 20, 28 and outer walls 18, 26. Ridges 58 preferably do not extend all the way down on outer walls 18, 26, but terminate a spaced distance from bottom walls 22, 30. Ridges 58 therefore cover a generally semicircular area to imitate a turtle's shell. Upper walls 20, 28 provide a safe, rounded portion for the young child's palm. Because ridges 58 are provided on both the upper walls 20, 28 and outer walls 18, 26, the dispenser 10 is more easily held in a small hand. A ridge-free zone 60 is formed on side walls 18, 26 between bottom ridge 62 and bottom walls 22, 30 A bump 64 is formed on rear section A between projection 50 and bottom ridge 62. Bump 64 imitates a turtle's tail but also provides a rest area for the edge of a child's hand, therefore aiding in preventing the child's hand from sliding off the dispenser 10. As may be seen from FIG. 1, ridges 58 may radiate outwardly from a ridge-free area 66 on first side 12. On second side 14, ridges 58 may radiate outwardly from an aperture 68 formed as tape support 32 is molded (FIG. 4).

A product information card 70 (FIG. 4A) may be inserted into dispenser 10. Card 70 may include an image of a turtle to enhance the appearance of the dispenser. Dispenser 10 also includes an opening 72 through which tape 34 can be seen and through which a free end thereof (not shown) can be accessed.

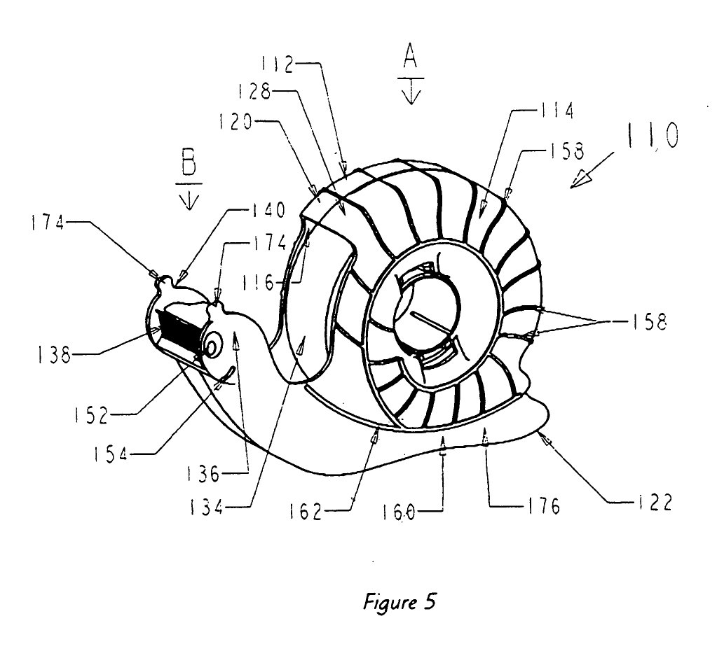

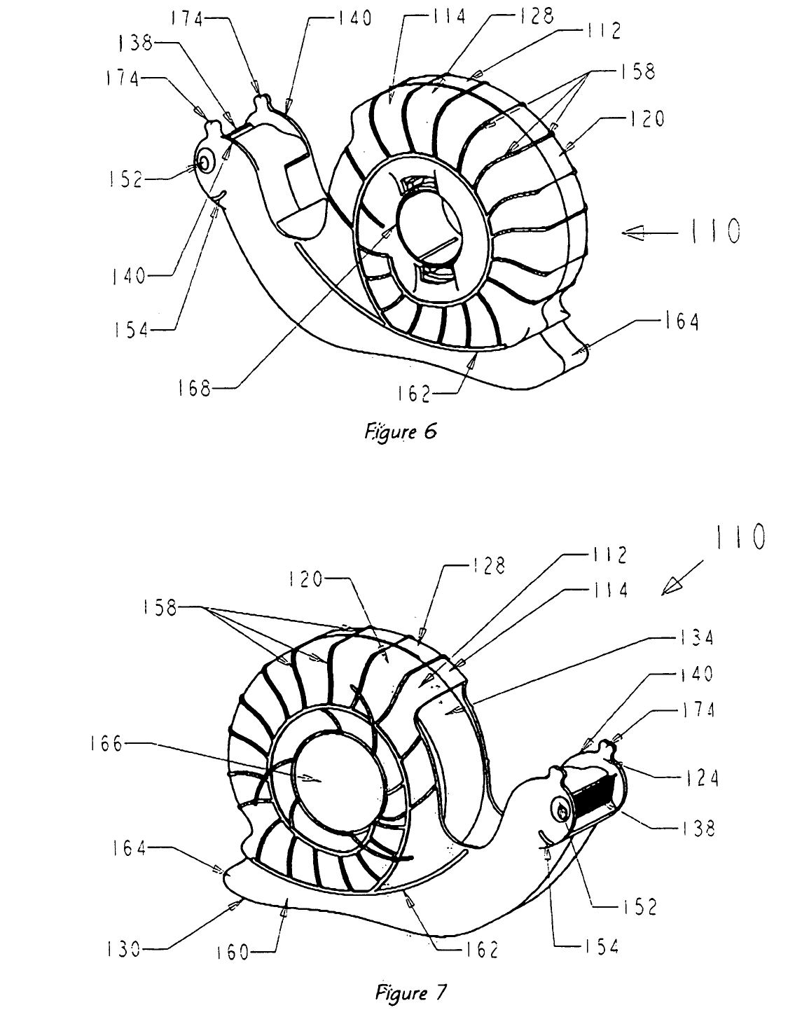

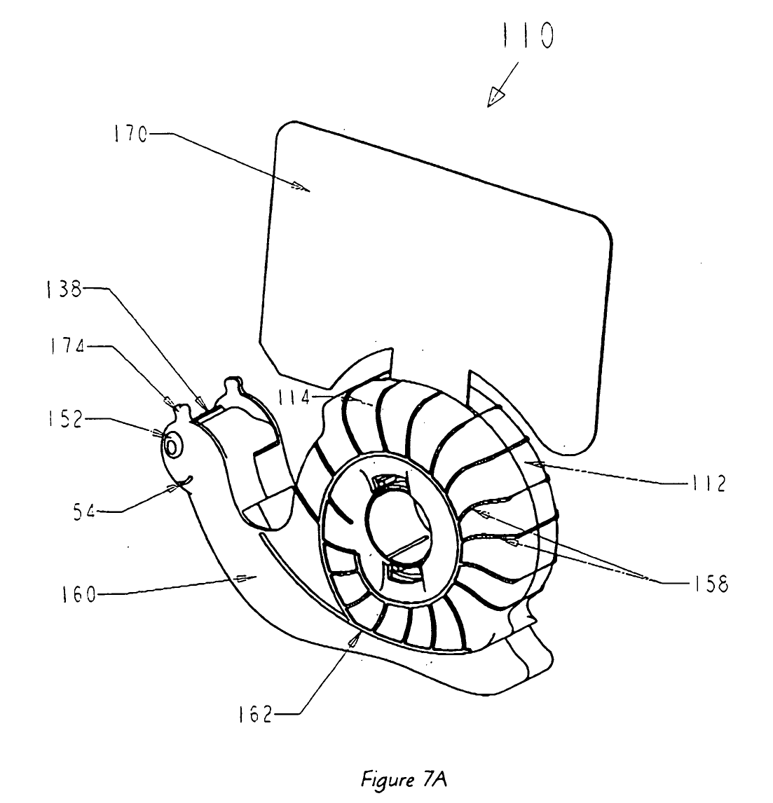

Referring to FIGS. 5-7A0, there is shown a second embodiment of tape dispenser in accordance with the present invention and generally indicated at 110. Dispenser 110 is shaped to represent a stylized snail and various features of the dispenser consequently differ from those of the first embodiment. First and second sides 112, 114 of dispenser 110 are formed with a rear section A and a forward section B. Forward section B of each of first and second sides 112, 114 includes an end portion 136 shaped as a snail's head and includes an eye 152 and a mount 154. An tab 174, representing an antenna, is formed rearwardly of eyes 152. Cutter blade 138 is mounted forward of tabs 174 and between end portions 136. Cutter blade 138 is mounted a spaced distance inwardly from outer edge 140. Rear section A is again substantially circular in shape and includes a plurality of ridges 158. Ridges 158 radiate outwardly from approximately the center of rear section A and are configured into a spiral shape to support the snail-like appearance of dispenser 110. As with the first embodiment, ridges 158 on dispenser 110 radiate outwardly from a ridge free area 166 on first side 112 and radiate outwardly from an aperture 168 in second side 114 formed when tape support (not shown) is molded. A single projection 176 is integrally formed with bottom walls 122, 130 of dispenser 110 (FIG. 5). Projection 176 is shaped as a snail's foot and may be used to stand dispenser 110 upright on a surface. A ridge-free zone 160 lies between bottom ridge 162 and projection 176. A bump 164 is formed either at the rear end of projection 176 or on bottom ridge 162 to provide a rest for the edge of a child's hand. A product display card 170 may be inserted into dispenser 110. Card 170 may include the image of a snail to enhance the appearance and appeal of dispenser 110.

In use, the dispenser 10 or 110 is held within the young child's hand. The following will be described with reference to dispenser 10, but applies equally to dispenser 110. The upper walls 20, 28 form a guard for the young child's palm and the pattern and presence of ridges 58 enable dispenser 10 to be gripped more easily in a small hand. The opening 72 allows the child to access a free end (not shown) of tape 34 and draw the same over cutter blade 38 to cut a piece of tape from the roll. The roll of tape 34 is held within a chamber formed between first and second walls 12, 14 and consequently as tape is pulled from the roll, the child's fingers cannot contact the rotating roll, nor do their fingers become stuck on the tape's adhesive side. Tape roll 34 is therefore free to rotate within dispenser 10 making it easier to cut a piece of tape from the roll. Furthermore, because cutter blade 38 is recessed within end portions 36, a piece of tape can be easily cut from the roll with a decreased chance of the child's fingers coming into contact with the blade 38.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A tape dispenser comprising;
a first side having an inner wall, an outer wall, an upper wall and a bottom wall;
a second side having an inner wall, an outer wall, an upper wall and a bottom wall; wherein said first and second sides are connected together and form a chamber adapted to receive a roll of tape therein; and wherein the first and second sides form a forward section and a rear section of the dispenser;
a plurality of ridges disposed on the rear section of the dispenser; and
a cutter blade mounted on an end portion of the forward section, the cutter blade being disposed inwardly of an outer edge of said end portion.

2. The tape dispenser as defined in claim 1, wherein the ridges are substantially polygonal in shape.

3. The tape dispenser as defined in claim 2, wherein the ridges are disposed in a semicircular area on the rear section of the dispenser.

4. The tape dispenser as defined in claim 3, wherein the ridges are shaped and positioned to give the rear section of the dispenser the appearance of a turtle shell.

5. The tape dispenser as defined in claim 4, further comprising a ridge-free area positioned centrally in the outer walls of the rear section of the dispenser and wherein the ridges are disposed around the ridge-free area.

6. The tape dispenser as defined in claim 5, wherein the ridges radiate outwardly from a central area of the rear section.

7. The tape dispenser as defined in claim 6, further comprising a ridge free area located in the central are of the rear section.

8. The tape dispenser as defined in claim 1, wherein the ridges form a spiral pattern around the ridge free area and wherein the ridges are shaped and patterned to give the rear section of the dispenser the appearance of a snail's shell.

9. The tape dispenser as defined in claim 8, further comprising a ridge-free zone disposed proximate the bottom walls of the first and second sides.

10. The tape dispenser as defined in claim 1, further comprising a card lying in abutting contact with the inner wall of at least one of the first and second sides; wherein the card includes an image of an animal.

11. The tape dispenser as defined in claim 10, wherein the image of the animal on the card is the image of one of a turtle and a snail.

12. The tape dispenser as defined in claim 1, wherein the end portion of the forward section is enlarged and the cutter blade is mounted within the enlarged end portion and is disposed inwardly of an outer edge of said end portion.

13. The tape dispenser as defined in claim 12, wherein the end portion is generally circular in shape.

14. The tape dispenser as defined in claim 13, wherein the end portion is shaped as the head of one of a turtle and a snail.

15. The tape dispenser as defined in claim 14, further comprising a tab extending upwardly and outwardly from the outer edge of the end portion; and
wherein the cutter blade is disposed forwardly of the tab.

16. The tape dispenser as defined in claim 1, wherein the rear section of the dispenser is generally circular in shape.

17. The tape dispenser as defined in claim 16, further comprising a first projection extending outwardly from the bottom walls of the first and second sides.

18. The tape dispenser as defined in claim 17, wherein the first projection extends outwardly from the rear section of the dispenser.

19. The tape dispenser as defined in claim 18, further comprising a second projection extending outwardly from the bottom walls of the first and second sides, and wherein the second projection lies a spaced distance from the first projection.

20. A tape dispenser comprising;
a first side having an inner wall, an outer wall, an upper wall and a bottom wall;
a second side having an inner wall, an outer wall, an upper wall and a bottom wall; wherein both of said first and second sides are formed in the shape of an animal and are connected together; and wherein the first and second sides form a forward section and a rear section of the dispenser;
a plurality of ridges disposed on the rear section of the dispenser; and
a cutter blade mounted on an end portion of the forward section, the cutter blade being disposed inwardly of an outer edge of said end portion.
